(19) United States
(12) Patent Application Publication
(10) Pub. No.: US 2008/0157524 A1
(43) Pub. Date: Jul. 3, 2008

(54) SELF-RESTRAINED DUCTILE IRON FITTING

(76) Inventors: Jim Jones, Aledo, TX (US); Bradford G. Corbett, Fort Worth, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 12/038,544

(22) Filed: Feb. 27, 2008

Related U.S. Application Data
(63) Continuation-in-part of application No. 11/149,988, filed on Jun. 10, 2005, now Pat. No. 7,328,493.

(51) Int. Cl. F16L 17/00; B23P 11/02; B21D 39/04

(52) U.S. Cl. 285/374; 29/525

(57) ABSTRACT

A combination sealing and restraint system for an as-cast ductile iron fitting is shown for both sealing and preventing separation of an iron pipe fitting and a mating male pipe. A sealing gasket body is provided with a series of integrally formed gripping segments. The gripping segments have teeth on an inner surface which are initially angled away from an outer surface of a mating male pipe. The teeth are forced into engagement with the exterior surface of the mating male pipe as the pipe joint at the fitting is assembled. The teeth are oriented to allow movement of the male pipe in a first direction relative to an end opening of the fitting during assembly, but to resist movement in a opposite direction after the fitting joint has been assembled. The combination sealing and restraining system is installed in the annular groove of the as-cast iron fitting after the iron casting operation at the factory.

### CROSS-REFERENCE TO RELATED APPLICATIONS

The present application is a continuation-in-part of Applicant' s prior U.S. application, Ser. No. 11/149,988, filed Jun. 10, 2005, entitled “Self Restrained Fitting for PVC and Ductile Iron Pipe.”

### BACKGROUND OF THE INVENTION

1. Field of the Invention:

The present invention relates generally to the field of pipe connections such as those used in the municipal water and sewer pipeline industries. More particularly, this invention relates to a combination sealing and restraint system for use in “as-cast” ductile iron pipe fittings.

2. Description of the Prior Art:

Pipes are commonly used for the conveyance of fluids under pressure, as in city water lines. They may also be used as free-flowing conduits running partly full, as in drains and sewers. Pipes for conveying water in appreciable quantities have been made of steel, cast iron, concrete, vitrified clay, and most recently, plastic including the various polyolefins and PVC.

In many applications where lengths of pipe are joined in telescoping relationship, the spigot end of one pipe is inserted into the socket end of the engaging pipe at a pipe joint or “coupling.” The socket end has an opening large enough to receive the spigot end of the mating pipe. A gasket is typically present within the socket end of the pipe which is intended to prevent leakage of fluid from the joint by forming a seal between the two pipe sections. Piping systems of the above type also typically include “fittings” as that term is defined in the industry. A fitting is a term which will be familiar to those in the relevant industries and includes a piece, often curved or at an angle, as a coupling, an elbow, a valve, a Tee, etc. used for connecting lengths of pipe or as an accessory to a pipe in a piping system for conveying fluids. Exemplary “as cast” ductile iron pipe fittings are shown, for example, in the Tyler/Union Utilities Mini-Catalogue, May 2001, on pages 2-3, as the “Mechanical Joint C153 Ductile Iron Compact Fittings.” These fittings are merely intended to be exemplary, as there are a number of other commercial sources for such pipe fittings.

One important consideration in piping systems of the above type, whether in a straight run of pipe or at a fitting, is to provide adequate sealing at the pipe joints or couplings. In addition to the necessity of providing effective sealing, another important design requirement exists when it becomes necessary to join the pipe components in a restrained manner. This is usually desired in order to prevent the pipe components from separating due to thrust forces that often occur when the pipeline is subjected to internal or external pressures, changes in direction or elevation of the pipeline, and sometimes when earthquakes or tremors or other external factors come into play.

A particularly preferred method of forming a sealed joint in straight runs of pipe is sometimes referred to as a “mechanical joint” or simply as an “MJ”. The bell end of an iron pipe section has a flanged portion cast on it. The spigot end of a second iron pipe is fitted with a slidable gland fitting and a gasket that is conically shaped such that one face of the gasket is diametrically larger than the second face of the gasket. The conically shaped gasket is positioned between the gland fitting and the spigot end of the pipe with the smaller, second face of the gasket being closer to the spigot end than the larger, first face of the gasket. The gland fitting has a plurality of apertures for receiving standard bolts. The joint is formed when the spigot is axially inserted into the bell, and the gland fitting and the flanged portion are bolted together, causing the lip of the gland fitting to compress the gasket thus sealing the two pipe pieces.

While the “internal” gasket used in the traditional MJ design for ductile iron pipe served to seal the joint, the gasket did not feature a cooperating “restraint” feature in order to assure the greater integrity of the joint of pipe. Instead, it was necessary to utilize a cumbersome external mechanical restraint system made up of the flange, bolts, screws, etc., as discussed above.

Also, when the pipe component being joined was a fitting rather than a straight run of pipe, there was less room available on the exterior of the fitting to accept the various parts (flanges, bolts, screws, etc.) that were necessary to make up the MJ type restraint.

A need exists, accordingly, for a sealing and restraint system for ductile iron pipelines, and particularly for fittings, which offers complimentary sealing and self restraining features in an internal sealing/restraint system.

A need also exists for such a system which is cost-effective, easy to manufacture and easy to use in the field and which is dependable in operation.

A need also exists for such a system which effectively restrains ductile iron fittings against internal and external forces without the need for an external flange, bolts or associated restraining screw mechanisms.

### SUMMARY OF THE INVENTION

The present invention has as one object to provide a combination sealing and restraint system for insertion within an annular groove within a mouth region located adjacent an end opening of an as-cast ductile iron fitting capable of both sealing and restraining the ductile iron fitting to a mating male pipe having an interior surface and an exterior surface.

The preferred combination sealing and restraint system includes an annular gasket body made of a resilient elastomeric material, the annular gasket body having an inner circumferential region and an outer circumferential region. When installed within the annular groove provided in the mouth region of the as-cast fitting, the outer circumferential region forms a seal with the fitting mouth region and the inner circumferential region forms a sealing surface for a mating male pipe section. A plurality of generally planar gripping segments extending perpendicularly outward from the annular gasket body at a predetermined spacing around the circumference of the annular gasket body. Each of the gripping segments has an inner planar surface and an outer planar surface separated by a thickness. The inner planar surface has at least one row of gripping teeth capable of engaging selected points on the exterior surface of the mating male pipe.

In one form, the sealing and restraint system features an annular gasket body that, when viewed in cross section, includes a leading nose region and a radially inwardly slanting sealing surface which forms a lip seal for engaging the mating male pipe end during insertion. The lip seal surface is joined to a secondary sealing surface, the secondary sealing surface comprising a planar circumferential region which terminates in an inside corner of the gasket. The inside corner is connected to an outer arcuate region of the gasket by a gently sloping exterior gasket surface. The outer arcuate region of the gasket is connected to the nose region of the gasket by a another gently sloping external gasket surface.

Preferably, the generally planar gripping segments are integrally formed into the leading nose region of the annular gasket body during manufacture of the gasket body. For example, the gasket body may be injection molded with the gripping segments being integrally formed into the gasket body during the injection molding operation. The gripping segments extend outwardly from the nose section of the gasket. The outer planar surface of the gripping segments is at least partly covered by the rubber of the nose region of the gasket. Preferably, the majority of the outer planar surface is covered with rubber. The amount of elastomer utilized and the durometer of the elastomer control the force of the gripping tooth engagement with the mating male pipe. In one preferred form of the invention, only a single row of gripping teeth are present on the inner planar surface of the gripping segments. Where two rows are present, one row has a greater relative height than the other row.

A method is also provided for forming a pipe joint with the sealing and restraining system described above. To begin, a fluid piping system is provided which has one or more as-cast ductile iron pipe fitting, previously cast at a foundry, each having a mouth region adjacent an end opening thereof. The mouth region has an annular groove therein, and the end opening of the fitting is sized to receive a mating male pipe having an interior surface and an exterior surface. In a post-casting operation, the sealing and restraining system is installed within the annular groove provided in the end opening of the as-cast fitting. The plurality of integrally formed gripping segments extend outwardly from the annular gasket body at a predetermined spacing around the circumference of the annular gasket body. The spacing is sufficient to allow the gasket body to be flexed to thereby allow the sealing and restraint system to be installed in the pipe during a post-casting operation. A mating male pipe is installed within the end opening of the mouth region of the as-cast fitting by pushing the male pipe within the end opening, and the sealing and restraint system contacts the external surface of the mating male pipe in order to both seal and restrain the mating male pipe and form a secure joint.

The mating male pipe may be made from a plastic material or from iron. In the case where the mating male pipe is formed of iron, the gripping segments are preferably formed of hardened steel which has been treated to at least about 370 Brinell hardness (BHN) so that the gripping teeth of the segments can penetrate the mating male iron pipe exterior surface or form a buttress on the pipe surface.

Additional objects, features and advantages will be apparent in the written description which follows.

### BRIEF DESCRIPTION OF THE DRAWINGS

FIG. 1 is a perspective view, partly broken away, of an as-cast ductile iron pipe fitting showing the combination sealing and restraint system of the invention in place within a mouth region of the fitting.

FIG. 2 is a partial sectional view of one end of the ductile iron pipe of FIG. 1 showing the combination sealing and restraint system thereof in greater detail.

FIG. 3A is a partial, sectional view of one end of the pipe fitting of FIG. 1, illustrating the assembly of the male pipe end.

FIG. 3B is a sectional view of the combination sealing and gripping system of FIG. 3A.

FIG. 4 is a perspective view of the combination sealing and restraint system of the invention.

FIG. 5 is a partial sectional view of a prior art MJ style restraint system.

FIG. 6 is a side, partial sectional view which shows another form of the sealing and restraint system of the invention in which the rubber of the nose region of the gasket covers the outer planar surface of the gripping elements.

FIG. 7 is an isolated, cross-sectional view of the sealing and restraint system used in FIG. 6.

FIG. 8 is a view of a C-shaped gasket which houses a split gripping ring or a plurality of gripping segments.

### DETAILED DESCRIPTION OF THE INVENTION

The present invention deals with piping systems of the type used in water, sewage and other municipal fluid conveyance systems. In the past, such pipelines were traditionally formed of a ferrous metal. By “ferrous metal” is meant iron and alloys of iron. For example, one type of ferrous metal which is commonly encountered in the water works industry is “ductile iron.” This particular type of metal is widely used because it offers a combination of a wide range of high strength, wear resistance, fatigue resistance, toughness and ductility in addition to the well-known advantages of cast iron-castability, machinability, damping properties and economy of production. It takes its name from the fact that it is “ductile” in nature, rather than being brittle, as was the case with earlier cast iron products and materials. Today, grades of ductile iron are available offering the option of choosing high ductility with grades guaranteeing more than 18% elongation, or high strength, with tensile strengths exceeding 120 ksi (825 MPa). Austempered ductile iron (ADI), offers even greater mechanical properties and wear resistance, providing tensile strengths exceeding 230 ksi (1600 Mpa).

In forming a pipeline of ductile iron components, one end of each section is typically enlarged, forming a “bell” at one end sufficient to join the next adjacent pipe section by receiving in the belled end the unenlarged or “spigot” end of the next adjacent length of pipe within the bell end opening. The inside diameter of the bell is formed sufficiently large to receive the spigot of the next section of pipe with sufficient clearance to allow the application of an elastomeric gasket or other sealing device designed to prevent leakage at pipe joints when a plurality of pipe lengths are joined to form a pipeline.

Straight runs of ductile iron pipe of the above type have, for many years, been joined by utilizing an elastomeric gasket which is compressed between the inside walls of the bell and the outside wall of a mating spigot end of the next pipe in a series of telescoped pipes. The gasket is typically retained within the groove provided in the bell end opening of the female pipe section. However, as discussed above, one problem which exists is finding a way to “restrain” the assembled pipe joints so that the joint will not be separated due to internal or external pressure, or due to environmental factors such as earth movement.

As mentioned in the background discussion of the invention, the iron pipe industry has generally addressed the problem of providing a restrained pipe joint by utilizing an external sealing “gland” or flange, sometimes referred to as a “mechanical joint” or simply as an “MJ”. The MJ style restraint has worked satisfactorily in the past on straight runs of pipe. However, fittings typically do not present as large an exterior surface for receiving the various components needed to make up the MJ type restraint. Also, an internal combination sealing and restraint system would offer greater ease and speed of assembly in the field. Because the gripping components would be internal rather than external, there would be less opportunity for corrosion of the metallic components in use.

Turning to FIG. 5, there is shown a typical mechanical joint of the prior art. The joint shown in FIG. 5 is formed between a pipe bell end 11 of one ductile iron pipe and the plain spigot end 13 of a second ductile iron pipe. The second pipe 13 is inserted into the belled end 11 of the enclosing pipe. The inner surface of the pipe bell end 11 has a retainer groove 17 for retaining a gasket 15. The belled pipe end 11 also has a flanged region 27 which includes a plurality of apertures 29. A circumferential gland 31 is sized to be received about an outer surface of the mating male ductile iron pipe. The gland 33 has a forward lip portion 35 which contacts and compresses the body of the gasket 15 as the joint is assembled. The gland 31 also has a plurality of apertures 37 which are arranged to be aligned with the apertures in the flange collar region of the bell pipe end. Bolts 39 and nuts 41 are used to join the apertures of the bell pipe end and the gland as shown in FIG. 5.

While the mechanical joint illustrated in FIG. 5 has been utilized for a number of years in the industry, it is somewhat cumbersome and time consuming to assemble. Additionally, the external metallic components are subject to wear, damage and corrosion. As mentioned above, it may be too bulky for use on some fittings. The present invention, therefore, has particular application to as-cast “fittings” which are used to make up a joint between two plain end pipe sections. By “as-cast” is meant that no additional machining is involved to form the bell, as with traditional systems. As-cast fittings of the type under consideration are commercially available from a number of sources, for example, the Tyler Pipe/Utilities Division of Union Foundry Company located in Anniston, Ala., as previously mentioned in the Background discussion.

While the invention will be primarily described with respect to ductile iron pipelines, it will be understood that the mating male pipe could also be formed of another material, such as a suitable plastic such as PVC or a suitable polyolefin such as polyethylene. Such “hybrid” systems are becoming increasingly common in use in the rehabilitation of existing ductile iron pipe lines.

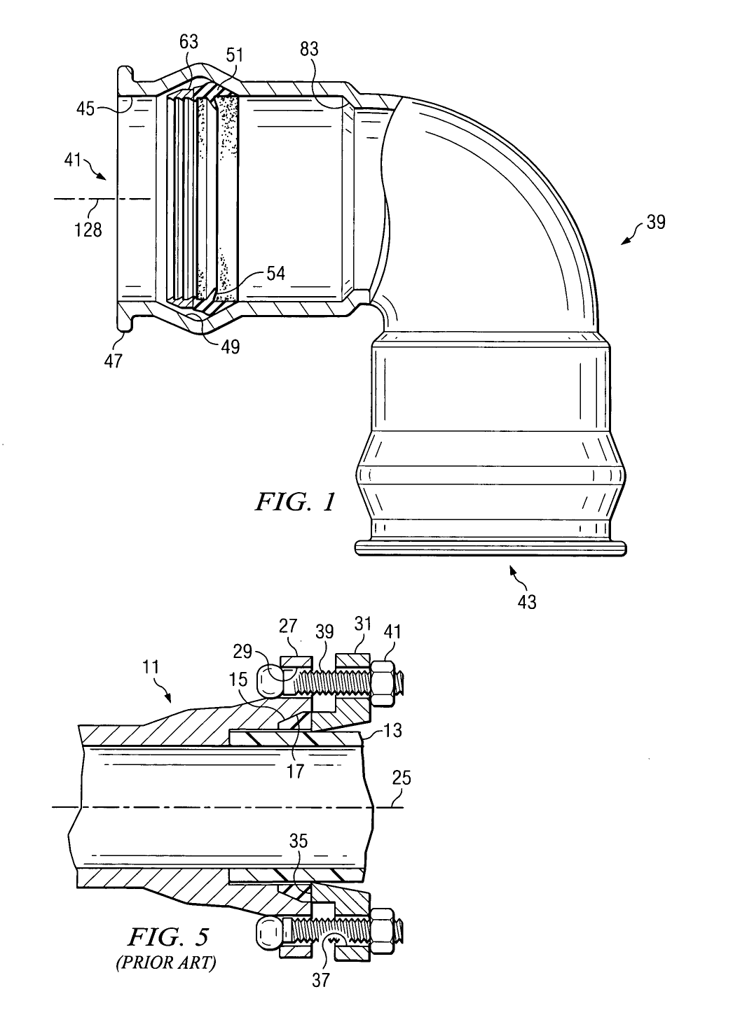

FIG. 1 illustrates an as-cast ductile iron elbow fitting which has installed therein the combination sealing and gripping restraint system of the invention. The as-cast fitting 39 illustrated in FIG. 1 has opposing end openings 41, 43. Each end opening has an adjacent mouth region (45 in FIG. 1) and can be provided with a slight upset 47. It is not necessary that the upset 47 be provided as an apertured flange, however. An annular groove 49 is provided within the mouth region 45 slightly spaced back from the end opening 41.

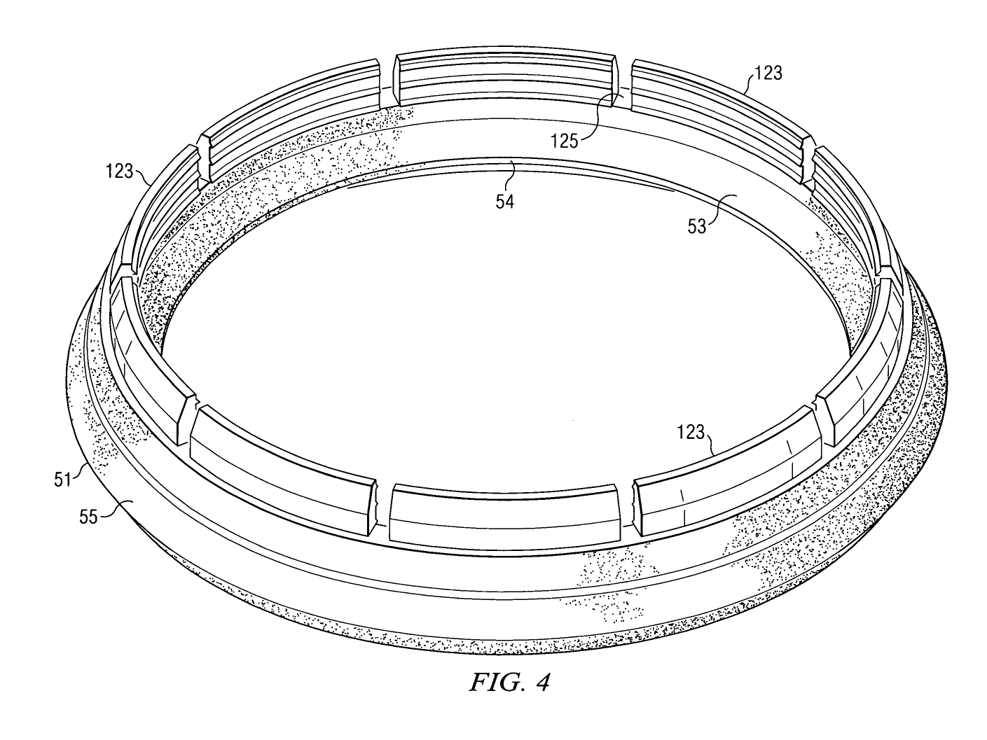

The combination sealing and restraint system of the invention includes an annular gasket body 51 (FIG. 1) having an inner circumferential region 53 and outer circumferential region 55 (see FIG. 4A). The annular gasket body 51 is installed within the annular groove 49 provided in the mouth region 45 of the as-cast fitting so that the outer circumferential region 55 forms a seal with the fitting mouth region and the inner circumferential region 53 forms a sealing surface for a mating male pipe section. The lip region 54 of the inner circumferential region 53 forms a primary lip seal for engaging the mating male pipe end during insertion.

One preferred form of the combination sealing and restraint system of the invention is shown in FIGS. 1-4. Turning to FIG. 4, the combination sealing and restraint system includes the previously described sealing gasket body, designated generally as 101, together with an integral restraint system. The gasket portion of the device (indicated generally at 101 in FIG. 3B) includes a leading nose region 103 which is joined to a radially inwardly slanting sealing surface 105. The inwardly slanting sealing surface 105 extends outwardly to form a lip seal region 107 for engaging the mating male pipe end during insertion. Whether the gasket body features a lip seal, as shown in FIG. 3B, or more of a bulbous “compression seal region”, the sealing surface of the gasket body will generally extend further radially inward (toward the centerline of the pipe) than the gripping surfaces of the companion gripping segments (123 in FIG. 4).

The lip seal region 107 of the gasket body is joined to a secondary sealing surface 111. The secondary sealing surface 111 comprises a generally planar circumferential region 113 which terminates in an inside corner 115 of the gasket. The inside corner 115 is connected to an outer arcuate region 117 of the gasket by a gently sloping exterior gasket surface 119. The outer arcuate region 117 of the gasket is connected to the nose region 103 of the gasket by a downwardly sloping external gasket surface 121.

A plurality of integrally formed gripping segments 123 (see FIG. 4) extend perpendicularly outward from the nose region 103 of the annular gasket body 101 at a predetermined spacing around the circumference of the annular gasket body 101. By “extending perpendicular outward” is meant that the segments extend generally along a 180 degree axis from the inside corner 115 of the gasket body. In the example shown, there are ten evenly spaced gripping segments. The gripping segments are typically formed of a metal such as steel, although the segments might be formed of a hard plastic where the mating male pipe to be gripped is formed of, for example, PVC. The number of gripping segments will vary depending upon the diameter of the sealing and gripping assembly. For example, in the case where the annular gasket body 101 has a six-inch diameter, nine separate gripping segments 123 will typically extend outwardly around the circumference of the gasket body 101. The gripping segments 123 are generally planar with a length, a width, an inner circumferential surface and an outer circumferential surface separated by a thickness. There exists a series of generally uniform gaps or spaces (generally shown at location 125 in FIG. 4) between each adjacent gripping segment. The gaps 125 between the metallic gripping segments 123 provide some degree of flexibility for the assembly, thereby facilitating its installation within the mouth region 41 of the pipe fitting 39. In some forms of the invention, the gaps 125 may be filled with rubber which is extruded as a part of the sealing gasket body, as well.

The gripping segments are preferably integrally formed into the leading nose region of the annular gasket body during manufacture of the gasket body. For example, the gasket body may be injection molded with the gripping segments being integrally formed into the gasket body during the injection molding operation. In that event, a portion of the length of the gripping segments would be enclosed within or be embedded within the elastomeric body of the sealing gasket. Alternatively, it may be possible to glue or otherwise adhere the gripping segments to the elastomeric gasket body in some circumstances so that the segments are held in the position shown in FIG. 4.

The inner planar surface of each gripping segment 123 has at least one row of teeth 127 capable of engaging selected points on the exterior surface of the mating male pipe. In the version of the device illustrated in FIG. 4, there are three rows of teeth 127 on the inner planar surface. As illustrated in FIG. 3B, the teeth are formed on an acute angle “α” with respect to a horizontal axis (illustrated as 128 in FIG. 1) of the mouth opening 45 once assembled within the as-cast fitting 39. The shape and inclined angle of the teeth allow a mating male pipe end to be received within the end opening 41 of the fitting 39 and move in a direction from right to left as viewed in FIG. 3A. However, the shape and inclined angle of the teeth 127 resist opposite relative movement of the mating male pipe 130 and thereby exert a restraining force on the mating male pipe 130 once the male pipe has be fully inserted into the fitting 39.

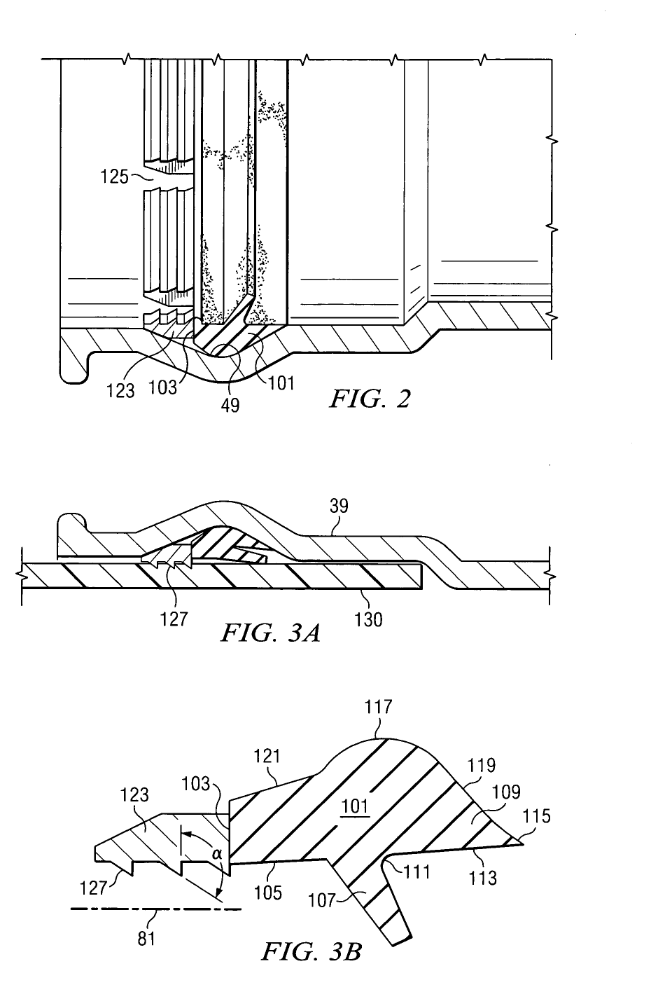

FIG. 2 provides an enlarged cross-sectional view of one end of the ductile iron pipe of FIG. 1, specifically showing the combination sealing and restraint system thereof in greater detail. The annular gasket body 101 of the sealing and restraint system is shown installed within the annular groove 49 provided in the mouth region of the as-cast fitting. The gripping segments 123 extend outwardly from the nose region 103 of the annular gasket body 101. As mentioned, there is a slight space between each gripping segment, as shown at location 125 which is either open, or which is filled with rubber.

As has been mentioned, the mating male pipe may be made from a plastic material, such as from PVC, or from iron. In the case where the mating male pipe is formed of iron, the gripping segments are preferably formed of hardened steel which has been treated to at least about 370 Brinell hardness (BHN) so that the gripping teeth of the segments can penetrate the mating male iron pipe exterior surface or form a buttress on the pipe surface.

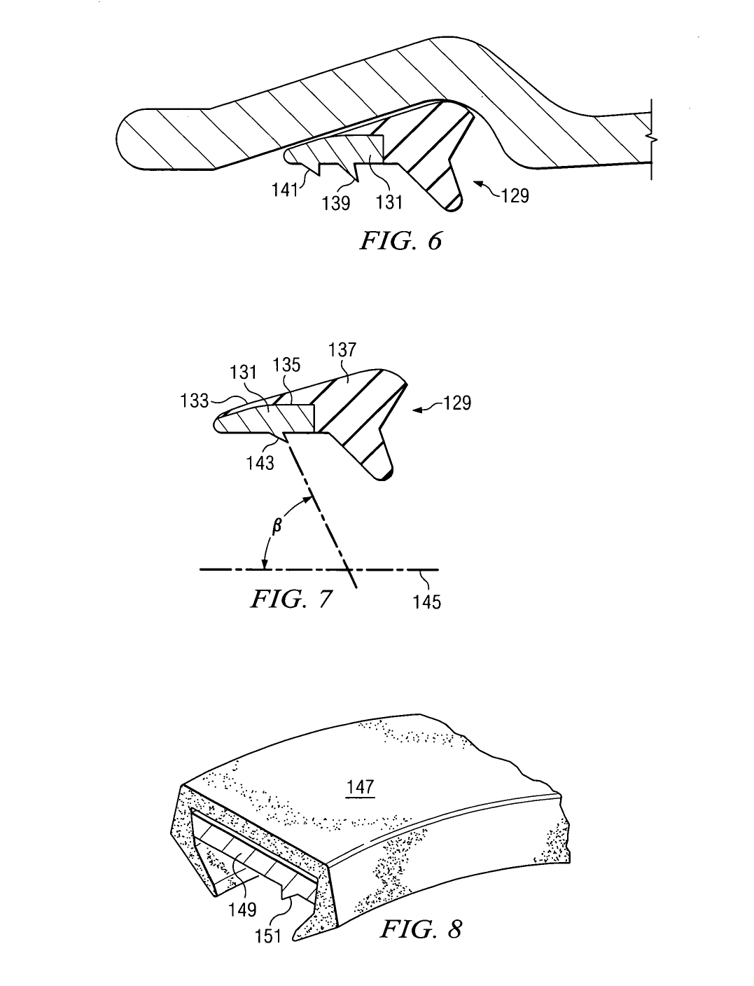

FIGS. 6 and 7 show another preferred form of the sealing and restraint system of the invention, designated generally as 129. The sealing and restraint system 129 is generally similar to that which has been previously described with respect to FIGS. 1 and 2-4. However, as best appreciated from the isolated view of FIG. 7, it will be seen that the gripping segments 131 now have at least a slight covering of rubber material on the outer planar surfaces 135 thereof. This is conveniently achieved as a part of the injection molding process of the elastomer portion 137. By providing a rubber covering layer on the outer planar surface of the gripping segments, the force which the teeth (139, 141 in FIG. 6) apply to the mating male pipe end can be more fully controlled. In other words, the amount of rubber present on the outer planar surfaces 135 and the durometer of the rubber will determine the amount of ultimate force which the combined sealing and restraint system applies to the mating male pipe.

With reference to FIG. 7, a preferred form of the sealing and restraint system of the invention is shown in which a single row of gripping teeth 143. Note that the teeth may be provided with a slight “hook” of backward angle “β” with respect to the central axis 145 of the female belled pipe end. In other words, the angle “β” is not perpendicular to the longitudinal axis 145. Where the gripping elements are provided with, for example two rows of teeth, one row will typically be taller than the other row.

While the elastomer body portion of the sealing and restraint system is shown in one form in FIGS. 6 and 7, it will be appreciated that it may take other forms, as well. For example, rather than a combined compression and lip seal design, as shown in FIGS. 6 and 7, the gasket body could be more of a traditional “C-shaped” gasket (147 in FIG. 8) having a generally C-shaped cross section.

Such C-shaped gasket designs are known and commercially available. See, for example, the Victaulic C-shaped Gasket For Water, Sewer and Drain Fittings, sold by Victaulic Corporation of Easton, Pa. In the case of the C-shaped gasket shown in FIG. 8, however, a plurality of gripping segments 149 are located on the underside of the gasket in a channel formed between the edges thereof. The segments 149 in FIG. 8 have at least one row of gripping teeth 151 on the inner planar surfaces thereof. With the C-shaped gasket, hydrostatic pressure acts to assist in the ultimate sealing action, making the gasket pressure responsive.

The operation of the sealing and restraint system of the invention will now be briefly described. The system will typically be utilized with a fluid piping system which includes one or more as-cast ductile iron pipe fittings. With reference to FIG. 1, the as-cast fitting 39 typically requires no modification from the item typically produced as-cast from the foundry. As mentioned earlier, it is not necessary for the upset 47 to be provided with apertures for receiving connecting bolts since the internal restraint system of the invention replaces the prior art external components. The combination sealing and restraint system is then typically installed within the internal groove 49 provided within the mouth region 45 of the fitting. The annular gasket body 101 is installed within the annular groove 49 so that the outer circumferential region forms a seal with the fitting mouth region and the inner circumferential region forms a sealing surface for a mating male pipe section.

As has been mentioned, the combination sealing gasket and gripping mechanism is inserted within the pipe mouth opening in a post cast operation, thus requiring the body to remain flexible for ease of insertion. The spacing between each gripping segment may assist in maintaining the flexibility of the gasket body. Alternatively, the gaps or spacing between segments may be filled with rubber from the elastomer body of the gasket. If the gripping segments are viewed as forming an imaginary ring, the diameter of the imaginary ring will be slightly less than the outer diameter of the mating male pipe which is inserted within the female, belled pipe end to form a pipe connection. This means that the gasket body nose region, with its associated gripping segments must be expanded at least slightly to pass over the outer diameter of the mating male pipe end. The inner circumferential surface of the gripping segments, with the rows of gripping teeth 127 are capable of engaging selected points on the exterior surface of the mating male pipe.

Once the sealing and restraint gasket is in place, the mating male pipe is installed within the end opening of the mouth region of the as-cast fitting by pushing the male pipe within the end opening. Upon insertion of the male pipe end, the sealing and restraint system contacts the external surface of the mating male pipe in order to both seal and restrain the mating male pipe and form a secure pipe joint.

An invention has been provided with several advantages. The combination sealing and restraint system of the invention is capable of joining and sealing an as-cast ductile iron fitting to a mating male pipe section. The system of the invention is simple in design and economical to manufacture and does not require any drastic changes in existing ductile iron components. The present invention can be used to join ductile iron fittings to mating pipe sections without the need for external mechanical restrain components which complicate assembly and can be subject to corrosion or deterioration in use. By providing the individual gripping segments with a backing of elastomer from the sealing gasket body, the ultimate gripping force of the gripping teeth can be more effectively controlled. Changing the amount of rubber, or the durometer of the rubber, changes the amount of force applied to the external surface of the mating male pipe.

While the invention has been shown in several of its forms, it is not thus limited but is susceptible to various changes and modifications without departing from the spirit thereof.

I claim:

1. A combination sealing and restraint system for insertion within an annular groove provided within a mouth region located adjacent an end opening of an as-cast ductile iron fitting capable of both sealing and restraining the ductile iron fitting to a mating male pipe having an interior surface and an exterior surface, the sealing and restraint system comprising:
an annular gasket body made of a resilient elastomeric material, the annular gasket body having an inner circumferential region and an outer circumferential region, the annular gasket body being installed within the annular groove provided in the mouth region of the as-cast fitting so that the outer circumferential region forms a seal with the fitting mouth region and the inner circumferential region forms a sealing surface for a mating male pipe section;
a plurality of generally planar metallic gripping segments extending perpendicularly outward from the annular gasket body at a predetermined spacing around the circumference of the annular gasket body;
wherein the gripping segments are comprised of an inner planar surface and an outer planar surface separated by a thickness, and wherein the inner planar surface has at least one row of gripping teeth capable of engaging selected points on the exterior surface of the mating male pipe and apply a gripping force to the exterior surface;
wherein the sealing surface of the annular gasket body extends further radially inward in a direction of a centerline of the mouth opening of the fitting than do the gripping teeth on the inner planar surfaces of the gripping segments; and
wherein the outer planar surfaces of the gripping segments are at least partly covered with elastomeric material from the gasket body, so that the gripping force exerted on the exterior surface of the mating male pipe can be controlled by varying the amount of elastomer and by varying the durometer of the elastomer.

2. The combination sealing and restraint system of claim 1, wherein the annular gasket body, when viewed in cross section, includes a leading nose region and a radially inwardly slanting sealing surface which forms a lip seal for engaging the mating male pipe end during insertion.

3. The combination sealing and restraint system of claim 1, wherein the annular gasket body, when viewed in cross section, is C-shaped with the gripping segments being carried on an inner circumferential surface thereof.

4. The combination sealing and restraint system of claim 1, wherein the generally planar gripping segments are integrally formed into the leading nose region of the annular gasket body during manufacture of the gasket body.

5. The combination sealing and restraint system of claim 4, wherein the gasket body is injection molded and the gripping segments are integrally formed into the gasket body during the injection molding operation.

6. The combination sealing and restraint system of claim 5, wherein the lip seal region of the gasket body is joined to a secondary sealing surface, the secondary sealing surface comprising a planar circumferential region which terminates in an inside corner of the gasket, the inside corner being connected to an outer arcuate region of the gasket by a gently sloping exterior gasket surface, the outer arcuate region of the gasket being connected to the nose region of the gasket by a similar gently sloping external gasket surface.

7. The combination sealing and restraint system of claim 1, wherein the gripping segments are evenly spaced about the nose region of the gasket body and are separated by a predetermined distance to form a series of gaps, the gap spacing being sufficient to allow the gasket body to be flexed for insertion into the mouth region of the fitting.

8. The combination sealing and restraint system of claim 7, wherein the gaps are filled with elastomeric material from the sealing gasket body during the molding operation.

9. A method of forming a pipe joint, the method comprising the steps of:
providing a fluid piping system including at least one as-cast ductile iron pipe fitting, previously cast at a foundry, having a mouth region adjacent an end opening thereof, the mouth region having an annular groove therein, the end opening of the fitting being sized to receive a mating male pipe having an interior surface and an exterior surface;
in a post-casting operation, installing a sealing and restraining system within the annular groove provided in the end opening of the as-cast fitting, the sealing and restraining system having an annular gasket body made of a resilient elastomeric material, the annular gasket body having an inner circumferential region and an outer circumferential region, the annular gasket body being installed within the annular groove provided in the mouth region of the as-cast fitting so that the outer circumferential region forms a seal with the fitting mouth region and the inner circumferential region forms a sealing surface for the mating male pipe section;
wherein a plurality of integrally formed gripping segments are provided for applying a gripping force to a mating male pipe, each having an outer planar surface extend outwardly from the annular gasket body at a predetermined spacing around the circumference of the annular gasket body, the spacing being sufficient to allow the gasket body to be flexed to thereby allow he sealing and restraint system to be installed in the mouth region of the pipe fitting as a post-casting operation; and
wherein the outer planar surfaces of the gripping segments are at least partly covered with elastomeric material from the gasket body, so that the gripping force exerted on the exterior surface of the mating male pipe can be controlled by varying the amount of elastomer and by varying the durometer of the elastomer.

9. The method of claim 8, wherein the gripping segments each have an inner circumferential surface and an outer circumferential surface separated by a thickness, and wherein the inner circumferential surface has a single row of gripping teeth capable of engaging selected points on the exterior surface of the mating male pipe.

10. The method of claim 8, further comprising the steps of thereafter installing a mating male pipe within the end opening of the mouth region of the as-cast fitting by pushing the male pipe within the end opening, the sealing and restraint system contacting the external surface of the mating male pipe in order to both seal and restrain the mating male pipe and form a secure joint.

11. The method of claim 10, wherein the mating male pipe is made from a plastic material.

12. The method of claim 10, wherein the mating male pipe is also made from iron.

13. The method of claim 10, wherein the mating male pipe is formed of iron and wherein the gripping segments are formed of hardened steel which has been treated to at least about 370 Brinell hardness (BHN) so that the gripping teeth of the segments can penetrate the mating male iron pipe exterior surface or form a buttress on the pipe surface.
